(19) United States
(12) Patent Application Publication
(10) Pub. No.: US 2008/0053541 A1
(43) Pub. Date: Mar. 6, 2008

(54) PRESSURE REGULATION DEVICE, IN PARTICULAR FOR AN OXYGEN EMERGENCY SUPPLY SYSTEM IN AN AIRCRAFT

(75) Inventors: Rudiger Meckes, Berkenthin (DE); Rudiger Conrad, Stockelsdorf (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: DRAGER AEROSPACE GMBH, Lubeck (DE)

(21) Appl. No.: 11/689,751

(22) Filed: Mar. 22, 2007

(30) Foreign Application Priority Data
Mar. 24, 2006 (DE) 10 2006 013 538.5

(51) Int. Cl. F16K 31/00

(52) U.S. Cl. 137/624.27

(57) ABSTRACT

A pressure regulation device is provided, in particular for an oxygen emergency supply system in an aircraft. The device includes at least two parallel conduits in each of which at least two controllable valves are arranged in series. Further, a pressure sensor is arranged on the exit side of the valve arrangement, for the detection of the actual pressure value, and a controller is provided, which is signal-connected to the pressure sensor and controls the valves.

### BACKGROUND OF THE INVENTION

The invention relates to a pressure regulation device, in particular for an oxygen emergency system in an aircraft.

With oxygen emergency supply systems in aircraft, it is usual to first reduce the oxygen pressure to a medium pressure of about 10 bar by way of a pressure-reducer connecting directly to the compressed gas container, and subsequently to relieve it in a pressure regulation device to the required mask pressure.

For this purpose, pressure regulation devices with two self-sufficient pressure regulators arranged parallel to one another are among those belonging to the state of the art. In the case of a defect of one of the pressure regulators in the closure position, to the extent that this may no longer be opened, the other pressure regulator ensures the oxygen supply to the oxygen mask or masks. Problems result with such pressure regulation devices when one of the pressure regulators blocks in the opened position, i.e., when the pressure regulator may no longer be closed. In this case, the complete oxygen reserve of the emergency oxygen supply is lost in a relatively short time, in the case that the line is not blocked in time by other means. Furthermore, with these pressure regulation devices, it is disadvantageous that tests of the operability of these pressure regulation devices are normally not possible in the condition installed in the aircraft, due to the large oxygen consumption which this entails. Hence, the pressure regulation device needs to be disassembled from the aircraft and subsequently installed again at certain time intervals, for maintenance purposes or for testing the operability.

### BRIEF SUMMARY OF THE INVENTION

Against this background, it is an object of the invention to provide a pressure regulation device of the known type, which with a simple and inexpensive design, has good reliability and ensures a simple testing of its operability.

The pressure regulation device according to an embodiment of the invention is described below specifically as a part of an oxygen emergency supply system in an aircraft, but may basically also be applied in a different manner. It comprises at least two parallel conduits, in which in each case at least two controllable valves are arranged in series. Besides this, a pressure sensor arranged at the exit side of the valve arrangement, for detecting the actual value, and a controller are provided, wherein the latter is signal-connected to the pressure sensor, and controls the valves.

The pressure regulation device serves for the pressure reduction of a gas under pressure, to a predefined pressure level. Proceeding from a conduit entry, an entry conduit in the pressure regulation devices branches into at least two parallel conduits. Designed in this manner, the pressure regulation device according to an embodiment of the invention has at least two flow paths through the pressure regulation device, which are independent of one another. Two or more valves are connected in series in each of the conduits, and these valves, activated by the controller independently of one another, are set into an opening or closing position, in order to relieve the entry pressure of the gas to a desired exit pressure. Advantageously, with the pressure regulation device according to the invention, a blocking of one of the valves in the closed position does not lead to a blocking of the flow through the pressure regulation device, since the at least one parallel conduit always still ensures a gas passage.

Apart from this redundancy with regard to possible flow paths, the invention however also provides for an advantageous redundancy with regard to the closeability of these flow paths. Thus, the at least two valves which are arranged behind one another in series in each of the conduits or flow paths, also permit a shut-off of these conduits when one of the valves is blocked in its open position, and a closure of this valve is no longer possible. Thus, the pressure regulation device according to the invention not only provides a greater reliability with regard to the regulation (closed-loop control) behavior, i.e., to the attainment of a predefined pressure desired value, but also reduces the risk of an undesired outflow of the pressure medium.

Besides this, the pressure regulation device permits the realization of a multitude of different regulation concepts. Thus, for pressure regulation, all valves may be activated simultaneously by the controller. It is also conceivable to use only one of the conduits through the pressure regulation device with the valves arranged therein, actively for pressure regulation, and to keep the remaining conduits closed, and to use them only for pressure regulation in the case of failure within the active conduit line, instead of this conduit line. It is, for example, also possible to use only one valve per conduit for pressure reduction, and to keep the remaining valves open.

The valves of the pressure regulation device are preferably designed to be actuatable in an electromotive manner, and are preferably activated by an electronic controller. This controller may be digital and software-controlled, or in the form of analog electronic componentry. The opening or closing activation of the valves is effected in the regulator on the basis of a desired pressure/actual pressure equalization according to a regulation setting fixed in the controller. The actual pressure is recorded by the pressure sensor for detecting the actual value, arranged on the exit side of the pressure regulation device. The pressure sensor is electrically connected by lead to the controller for transmission of the signal of the actual pressure, so that the signal of the pressure sensor may either be conducted further to the controller in a direct manner or in a converted form suitable for the controller.

The controller is advantageously designed in a manner such that it permits a sequential activation of each of the applied valves. In this way, a functional testing of the pressure regulation device is also possible in the condition installed in the aircraft. The functional testing may be carried out on the ground or also during a normally running flight phase. Here, on testing the valves, in each case only the valve to be tested is opened briefly, and then closed again, while the remaining valves remain closed. Due to this procedure, with the pressure regulation device according to the invention, only a relatively small quantity of oxygen is lost during the testing, which is determined essentially by the volume of the conduit section located between the shut-off valves.

The desired pressure, to which the gas should be relieved in the pressure regulation device according to the invention, may be predetermined in a fixed manner and stored in the controller. In particular however, where the pressure regulation device forms a part of an oxygen emergency supply in an aircraft, the required desired pressure varies in dependence on the altitude. Thus, in the case of a sudden pressure drop in the machine, the passengers need to be provided with an increasing amount of oxygen with an increasing flight altitude. For this reason, the pressure regulation device according to the invention, in an advantageous further embodiment, comprises means for determining a desired pressure required at the exit side of the valve arrangement. With the application of the pressure regulation device according to the invention in an aircraft, these means determine the desired pressure usefully on the basis of the ambient pressure dependent on the altitude. Here, the means may be designed, for example, such that they convert the values for the altitude, provided by the altimeter or a GPS-system, into the pressure values corresponding with these.

Preferably, the means for determining a desired pressure required at the exit side of the valve arrangement comprise an ambient pressure sensor, which is signal-connected to the controller. This ambient pressure sensor may be arranged such that it detects the air pressure outside the aircraft. Advantageously, the ambient pressure sensor is arranged, however, such that it records the pressure prevailing in the aircraft cabin. In order to exclude there being no value for the desired pressure available to the controller in the case of a defect of the ambient pressure sensor, several ambient pressure sensors may be provided, so that in this case too there exists a redundancy, and a desired pressure is indicated to the controller, even with a failure of one of the ambient pressure sensors.

In the pressure regulation device according to the invention, the valves may be designed as shut-off valves or as throttle valves. Thus, one advantageous design of the pressure regulation envisages at least one valve being designed as a shut-off valve. The shut-off valve in a first position permits a flow path through the valve, and in a second position permits the complete blockage of this flow path. Accordingly, the shut-off valve or shut-off valves are designed as 2/2-way valves, with which a first valve position represents a blocking position, and the second position a through-flow position. The shut-off valve is preferably designed as a seat valve. This design permits a particularly good sealing of the flow path running through the valve, and accordingly has good operational reliability with regard to undesired escape of the gas. Optionally, the shut-off valve may, however, also be designed as a sliding valve.

In a further advantageous embodiment of the pressure regulation device, at least one valve is designed as a throttle valve. Here, the cross section of the flow path through the throttle valve may be continuously adjusted from a position closing the flow path to a position releasing the flow cross section. In this manner, the throttle valve permits a finer regulation of the exit pressure of the pressure regulation device.

Each valve of the pressure regulation device according to the invention advantageously comprises at least one end position switch or contact switch specifying the open position. Preferably, the valves are equipped with end position switches in the open as well as the closed position, wherein the end position switches or contact switches indicate whether a valve is closed or fully opened. This valve design is particularly useful for the functional testing of the pressure regulation device, since it permits an uncomplicated testing of the valves.

With the use of throttle valves it is particularly advantageous for the valves to comprise position sensors. This design permits a greater variety of regulation concepts, since in this manner one may set certain throttle cross sections at the valves. This setting of the throttle cross sections also permits a further advantageous design of the pressure regulation device according to the invention, wherein stepper motors are provided for actuating the valves.

Another favorable design of the pressure regulation device according to the invention envisages a pressure sensor arranged on the entry side of the valve arrangement, which is signal-connected to the controller. Particularly in combinations of valves provided with a position sensor or actuated by stepper motors, this design in combination with suitably designed electronics of the controller permits an evaluation of the quantity or the volume of the compressed gas to be relieved.

With the pressure regulation device according to the invention, its is advantageously envisaged for all valves first to be activated by the controller in parallel, and then for the pressure which sets in at the exit side of the pressure regulation device to be detected by a pressure sensor. When using controllable throttle valves for pressure reduction, the controller is designed in a manner such that it adjusts the throttle cross section according to an equalization of the actual pressure and the desired pressure of one or more of the throttle valves. With the use of shut-off valves for pressure reduction, it is also conceivable, on account of an equalization of the actual and desired pressure, for the controller to set a digital cycle frequency for a very rapidly alternating opening and closing of one or more of the shut-off valves.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic diagram of a pressure regulation device according to one embodiment of the invention, as part of an oxygen emergency supply system in an aircraft.

### DETAILED DESCRIPTION OF THE INVENTION

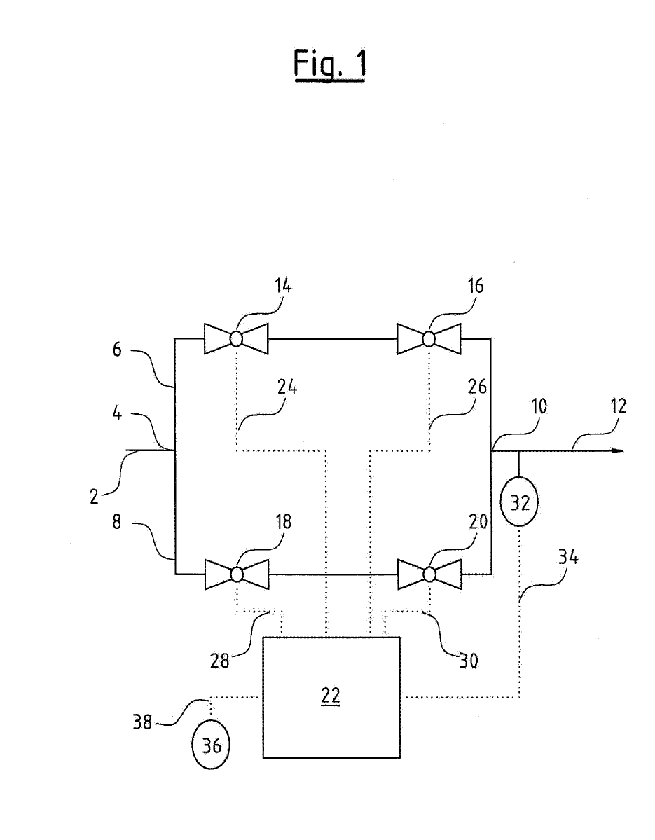

The pressure regulation device for the embodiment shown in FIG. 1 is arranged in the oxygen emergency supply system of an aircraft, which is otherwise not shown, in a medium pressure region in the conduit connection between an oxygen storage tank and the oxygen masks of passengers and crew. The pressure regulation device in this embodiment is envisaged for relieving the oxygen pressure of about 10 bar prevailing in this medium pressure region to the required mask pressure.

The oxygen is supplied to the pressure regulation device via an entry conduit 2 arranged on the entry side. A conduit branching 4, from which two conduits 6 and 8 branch, connects to this entry conduit 2. Proceeding from the conduit branching 4, the conduits 6 and 8 are led parallel to one another, until they reunite again into a common exit conduit 12 at a conduit junction 10.

Two electrically actuatable valves 14 and 16 are arranged one after the other in the conduit 6. Two electrically actuatable valves 18 and 20 are connected one after the other in the conduit 8. The actuation of the valves 14, 16, 18 and 20 is effected independently of one another via an electronic controller 22. For this, the valve 14 is electrically connected via a control lead 24, the valve 16 via a control lead 26, the valve 18 via a control lead 28, and the valve 20 via a control lead 30, to the electronic controller 22. The controller 22 is designed in a manner such that it permits the individual activation of one of each of the valves 14, 16, 18 and 20.

A pressure sensor 32 is arranged in the exit conduit 12. This pressure sensor 32 detects the gas pressure in the exit conduit 12 at the exit side of the valve arrangement formed by the valves 14, 16, 18 and 20. The pressure sensor 32 further transmits the detected pressure values to the controller 22 via a control lead 34. An ambient pressure sensor 36, which is preferably arranged within the cabin region in the aircraft and records the air pressure in the cabin, is connected to the electronic controller 22 via a control lead 38.

The air pressure in the cabin forms the basis for the desired pressure to be supplied by the pressure regulation device. The actual value of the pressure which is provided for the controller by the pressure sensor 32 is compared to this desired pressure, whereupon the controller 22 in the case of an actual pressure which is too low, activates one or more valves 14, 16, 18 and 20 to open, or activates the valves 14, 16, 18 and 20 to close in the case of an actual pressure which is too high.

The manner of operation of the pressure regulation device is hereinafter described by way of the drawing FIGURE.

First, all valves 14, 16, 18 and 20 of the pressure regulation device are located in their position closing the conduits 6 and 8. In case of an emergency situation necessitating the application of oxygen, all valves 14, 16, 18 and 20 may be activated briefly by the controller 22 into a position opening the conduits 6 and 8. Alternatively, it is also possible to keep the valves 14 and 16 or 18 and 20 closed, so that one of the conduits 6 or 8 remains closed off, while the flow path through the pressure regulation device is released by the opening of the valves 14 and 16 or 18 and 20 of the other conduit 6 or 8. The oxygen actual pressure resulting by this emergency situation on the exit side of the junction 10 in the exit conduit 12 is detected by the pressure sensor 32, and is conducted further via the control lead 34 to the controller 22. The actual pressure is compared in the controller 22 to the required desired pressure, whereupon the controller 22 causes a closure of the open valves 14, 16, 18 and 20 or an opening of these valves 14, 16, 18 and 20, depending on whether the actual pressure is higher or lower than the desired pressure. The evaluation of the required desired pressure is effected on the basis of an ambient pressure measured by an ambient pressure sensor 36, which is arranged in the cabin region of the aircraft and which transfers the values of the air pressure of the cabin to the controller 22.

The case of failure of one of the valves 14, 16, 18 and 20 will now be explained by way of example of a defect in valve 16 in the conduit 6.

The closed valve 16 comprises a defect which renders its opening no longer possible. Thus the defect in valve 16 prevents the flow through the conduit 6 to the exit conduit 12. A pressure regulation by way of the valves 14 and 16 is thus not possible. The pressure regulation in this case is effected via at least one of the valves 18 and 20, which are arranged in the conduit 8 and which are activated by the controller in a closing or opening manner, depending on the difference between the desired pressure and the actual pressure.

If the oxygen flow through the pressure regulation device is to be stopped after an emergency situation and the valve 16 has such a defect that it may no longer be closed, the intact valve 14 permits a blocking of the conduit 6, while the valves 18 and 20 close the conduit 8.

Finally, the testing of the operability of the valves 14, 16, 18 and 20 is described by way of example. All valves 14, 16, 18 and 20 are closed at the beginning of the testing procedure. The testing of the valves 14, 16, 18 and 20 is effected individually one after the other. If the valves 14, 16, 18, 20 in their open position and in their closed position comprise end position switches, not shown in the FIGURE, the end position switches in the closed position of the valves 14, 16, 18 and 20 produce a signal, which in each case indicates the closed condition of the valve.

For testing the valve 14, this is activated in an opening manner by the controller 22, while the remaining valves 16, 18 and 20 are kept closed. If the valve 14 may be opened, then the end position switch of the valve 14 is activated in the open position, which produces a signal indicating the opened condition of the valve 14. Subsequently, the valve 14 is activated by the controller in a closing manner. With a perfect functioning of the valve 14, the end position switch is again activated in the closure position which then produces the respective signal. The testing of the valve 16 is effected analogously to the testing of the valve 14, wherein the valve 16 is opened for testing, while the valves 14, 18 and 20 are closed. During the testing of the valve 14, no compressed gas may flow out of the conduit 6, since this is blocked by the valve 16. Only on testing the valve 16 does gas get into the subsequently arranged conduit system. The exiting gas quantity however is very low due to the closed valve 14, and is determined essentially by the volume of the conduit section of the conduit 6 between the valves 14 and 16. The testing of the valves 18 and 20 is effected in the same manner as has been described by way of the valves 14 and 16.

Alternatively or additionally, the testing of the functionality of the pressure regulation device may also be effected via a pressure measurement at the exit side of the pressure control device. With this type of testing, a throttled gas outlet is provided usefully in the exit conduit 12 on the exit side of the pressure regulation device, and this permits a pressure equalization in the exit conduit 12 depending on the testing procedure. This gas outlet is heavily throttled, so that only a small gas quantity may flow out. Either the pressure sensor 32 or an additional pressure sensor may be used for pressure measurement. All valves 14, 16, 18 and 20 are closed at the beginning of the testing procedure. First, the valve 14 alone is opened briefly, and subsequently closed again. If the valve 14 may be opened in a correct manner, then compressed gas flows into the conduit section of the conduit 6 between the valves 14 and 16. The valve 16 is opened after the valve 14 has been closed again. If the valve 16 may be opened, the compressed gas located between the valves 14 and 16 may flow out of the conduit 6 into the exit conduit 12, and there leads to a brief pressure increase which is recorded by the pressure sensor 32. This pressure increase is very low if the valve 14 was able to close in a correct manner. The valve 16 is subsequently closed. The valves 18 and 20 are tested in a manner analogous to the valves 14 and 16.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A pressure regulation device comprising at least two parallel conduits (6, 8), a valve arrangement comprising at least two controllable valves (14, 16, 18, 20) arranged in series in each of the two parallel conduits, a pressure sensor (32) arranged on an exit side of the valve arrangement for detection of an actual pressure value, and a controller (22) signal-connected to the pressure sensor (32), wherein the controller controls the valves (14, 16, 18, 20).

2. The pressure regulation device according to claim 1, further comprising means for determining a desired pressure required on the exit side of the valve arrangement.

3. The pressure regulation device according to claim 2, wherein the means for determining a desired pressure required on the exit side of the valve arrangement comprises an ambient pressure sensor (36) signal-connected to the controller (22).

4. The pressure regulation device according to claim 1, wherein at least one of the controllable valves (14, 16, 18, 20) is designed as a shut-off valve.

5. The pressure regulation device according to claim 1, wherein at least one of the controllable valves (14, 16, 18, 20) is designed as a throttle valve.

6. The pressure regulation device according to claim 1, wherein each of the controllable valves (14, 16, 18, 20) has at least one end position switch indicating an open position.

7. The pressure regulation device according to claim 1, wherein the controllable valves (14, 16, 18, 20) comprise position sensors.

8. The pressure regulation device according to claim 1, further comprising stepper motors for actuating the valves (14, 16, 18, 20).

9. The pressure regulation device according to claim 1, further comprising a pressure sensor arranged on an entry side of the valve arrangement and signal-connected to the controller (22).

10. The pressure regulation device according to claim 1, wherein the device is located in an oxygen emergency supply system of an aircraft
